(19) United States
(12) Patent Application Publication
(10) Pub. No.: US 2025/0094425 A1
(43) Pub. Date: Mar. 20, 2025

(54) APPROXIMATE NEAREST NEIGHBOR SEARCH OF DATA FROM STORAGE

(71) Applicant: Kioxia Corporation, Tokyo (JP)

(72) Inventor: Gaku UCHIDA, Yokohama Kanagawa (JP)

(21) Appl. No.: 18/821,633

(22) Filed: Aug. 30, 2024

(30) Foreign Application Priority Data
Sep. 15, 2023 (JP) 2023-150461

(51) Int. Cl. G06F 16/2455; G06F 16/22

(52) U.S. Cl. CPC G06F 16/24561; G06F 16/2237

(57) ABSTRACT

A method for searching data from a storage is provided. The method includes, in response to a query, selecting one or more candidate posting lists among a plurality of posting lists, based on a distance between a query vector corresponding to the query and a representative vector of each of the plurality of posting lists, acquiring the one or more candidate posting lists from the storage, decompressing one or more compressed posting lists included in the one or more candidate posting lists, after the decompressing, selecting one or more vectors included in the one or more candidate posting lists based on a distance between the query vector and each of vectors included in the one or more candidate posting lists, and outputting one or more searchable data pieces corresponding to the selected one or more vectors as an answer to the query.

### CROSS-REFERENCE TO RELATED APPLICATION(S)

This application is based upon and claims the benefit of priority from Japanese Patent Application No. 2023-150461, filed Sep. 15, 2023, the entire contents of which are incorporated herein by reference.

### FIELD

Embodiments described herein relate generally to an information processing apparatus, an information processing system, and an information processing method related to approximate nearest neighbor search of data from storage.

### BACKGROUND

The importance of unstructured data is increasing with the aim of improving business efficiency using IT technology. A data amount of the unstructured data tends to be larger than a data amount of structured data. A technique called an approximate nearest neighbor search is known as a technique for searching such a large amount of unstructured data for desired data. In the approximate nearest neighbor search, a plurality of pieces of searchable data stored in a memory is searched to find data close to a query, which is input data, based on vector information associated with each of the plurality of pieces of searchable data. In the approximate nearest neighbor search, a distance between a query vector corresponding to the query and the vector information of each of the plurality of pieces of searchable data is calculated to search for vector information in the vicinity of the query vector without obtaining a strict neighboring point for the query. In such an approximate nearest neighbor search, to address increase in an amount of the searchable data and a memory cost, a technique of executing data search in a state in which a part of the searchable data is stored in a storage apparatus having a capacity larger than that of the memory is proposed.

### BRIEF DESCRIPTION OF THE DRAWINGS

FIG. 1 is a schematic diagram illustrating an outline of an approximate nearest neighbor search based on usage of a storage apparatus.

FIG. 2 is a block diagram illustrating an example of a configuration of an information processing system according to an embodiment.

FIG. 3 is a block diagram illustrating an example of a hardware configuration of an information processing apparatus provided in the information processing system according to the embodiment.

FIG. 4 is a block diagram illustrating an example of a hardware configuration of a storage apparatus provided in the information processing system according to the embodiment.

FIG. 5 is a block diagram illustrating an example of a functional configuration of the information processing system according to the embodiment.

FIG. 6 is a block diagram illustrating another example of the functional configuration of the information processing system according to the embodiment.

FIG. 7 is a flowchart illustrating an overall flow of the approximate nearest neighbor search performed by the information processing system according to the embodiment.

FIG. 8 is a flowchart illustrating an example of index generation processing in the approximate nearest neighbor search performed by the information processing system according to the embodiment.

FIG. 9 is a diagram illustrating an example of compression of a posting list in the index generation processing in the approximate nearest neighbor search performed by the information processing system according to the embodiment.

FIG. 10 is a diagram illustrating another example of the compression of the posting list in the index generation processing in the approximate nearest neighbor search performed by the information processing system according to the embodiment.

FIG. 11 is a diagram illustrating still another example of the compression of the posting list in the index generation processing in the approximate nearest neighbor search performed by the information processing system according to the embodiment.

FIG. 12 is a sequence diagram illustrating an example of a processing sequence of search processing in the approximate nearest neighbor search performed by the information processing system according to the embodiment.

FIG. 13 is a flowchart illustrating an example of the search processing in the approximate nearest neighbor search performed by the information processing system according to the embodiment.

### DETAILED DESCRIPTION

Embodiments provide an information processing apparatus, an information processing system, and an information processing method for preventing deterioration in search accuracy and reducing latency.

In general, according to an embodiment, a method for searching data from a storage that stores a plurality of searchable data pieces indexed in a form of a structure that includes a plurality of posting lists, each of the posting lists including (1) one or more vectors, each of the one or more vectors corresponding to one of the searchable data pieces, and (2) a representative vector of the one or more vectors, at least one of the posting lists being stored in a compressed state in the storage is provided. The method includes, in response to a query, selecting one or more candidate posting lists among the plurality of posting lists, based on a distance between a query vector corresponding to the query and the representative vector of each of the plurality of posting lists, acquiring the one or more candidate posting lists from the storage, decompressing one or more compressed posting lists included in the one or more candidate posting lists, after said decompressing, selecting one or more vectors included in the one or more candidate posting lists based on a distance between the query vector and each of vectors included in the one or more candidate posting lists, and outputting one or more searchable data pieces corresponding to the selected one or more vectors as an answer to the query.

Hereinafter, an embodiment will be described with reference to the drawings. It is noted that the drawings are schematic or conceptual. Elements having substantially the same function and configuration are denoted by the same reference numeral. Numbers, alphabets, and the like added to the reference numerals are used to distinguish similar elements that are referred to by the same reference numeral.

### 1 Embodiment

An information processing apparatus, an information processing system, and an information processing method according to an embodiment can suitably execute an approximate nearest neighbor search based on usage of a storage apparatus.

### 1.1 Outline of Approximate Nearest Neighbor Search Based on Usage of Storage Apparatus in Embodiment

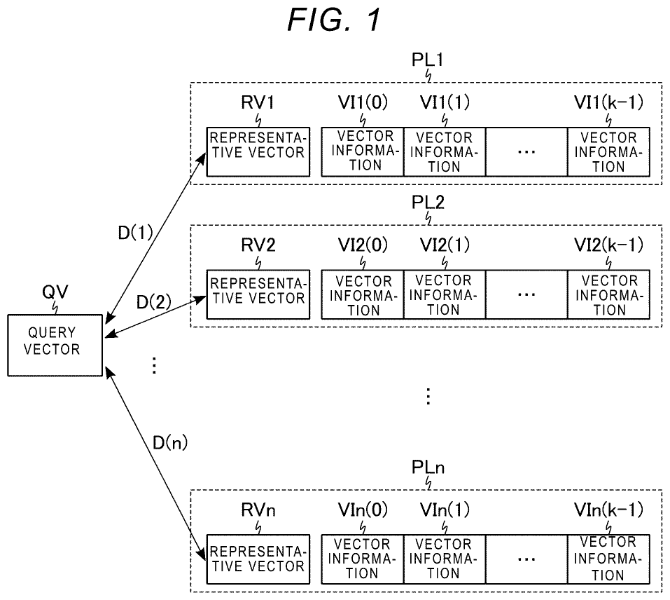

First, an outline of the approximate nearest neighbor search based on the usage of the storage apparatus in the embodiment will be described using FIG. 1. FIG. 1 is a schematic diagram illustrating the outline of the approximate nearest neighbor search based on the usage of the storage apparatus.

As one type of the approximate nearest neighbor search based on the usage of the storage apparatus such as a solid state drive (SSD) or a hard disk drive (HDD), a highly-efficient billion-scale approximate nearest neighbor search (SPANN) is proposed. Hereinafter, an outline of the SPANN will be described as an example of the approximate nearest neighbor search based on the usage of the storage apparatus.

Searchable data in the present disclosure corresponds to target data of the approximate nearest neighbor search executed based on a query. Data is distinguished, for example, into structured data that is structured and unstructured data that is not structured. The structured data is data organized in columns and rows. Since the structured data is structured, it is easy to perform search, aggregation, compare, and the like, and it is suitable for data analysis. Examples of the unstructured data include office document data such as e-mails, proposals, plans, estimates, purchase orders, and contracts, image data, video data, audio data, and sensor logs. The unstructured data has a wide variety of usages. The searchable data in the present disclosure is the unstructured data. The unstructured data is associated with, for example, vector information that characterizes the unstructured data. Hereinafter, the vector information is also simply referred to as a vector. In the approximate nearest neighbor search, for example, the vector information stored in the storage apparatus is used to search for a correct vector. The correct vector in the approximate nearest neighbor search is vector information in the vicinity of a query vector based on the query. The correct vector is searched for based on, for example, a distance between the query vector and the vector information.

The approximate nearest neighbor search includes, for example, index generation processing and search processing.

In the index generation processing, a plurality of pieces of vector information VI are classified into a plurality of posting lists PL1 to PLn (n is an integer equal to or larger than 2). Each of the plurality of pieces of vector information VI is associated with one of a plurality of pieces of unstructured data. It is noted that in the following description, when the plurality of posting lists PL1 to PLn are not distinguished from one another, each of the plurality of posting lists PL1 to PLn is simply referred to as a posting list PL. Each posting list PL includes the plurality of pieces of vector information VI. It is noted that the number of pieces of vector information VI included in each posting list PL may be the same or different. FIG. 1 illustrates, for example, a case in which each of the posting lists PL1, PL2, . . . , and PLn includes k pieces of vector information VI. The plurality of posting lists PL1 to PLn may be used for searching for the correct vector in the search processing.

The plurality of posting lists PL include, for example, a plurality of representative vectors RV associated with the plurality of posting lists PL, respectively. The representative vector RV is, for example, a center-of-gravity vector of the plurality of pieces of vector information VI included in the posting list PL associated with the representative vector RV, or vector information VI closest to the center-of-gravity vector among the vector information VI included in the posting list PL. The plurality of representative vectors RV may be presented in a form of, for example, a graph, a tree structure, or the like (hereinafter, simply referred to as a graph). The graph functions, for example, as an index used in the search processing.

The plurality of posting lists PL1 to PLn will be described more specifically. The posting list PL1 includes a representative vector RV1 and a plurality of pieces of vector information VI1. The representative vector RV1 is, for example, a center-of-gravity vector of the plurality of pieces of vector information VI1. The posting list PL2 includes a representative vector RV2 and a plurality of pieces of vector information VI2. The representative vector RV2 is, for example, a center-of-gravity vector of the plurality of pieces of vector information VI2. The posting list PLn includes a representative vector RVn and a plurality of pieces of vector information VIn. The representative vector RVn is, for example, a center-of-gravity vector of the plurality of pieces of vector information VIn.

Each posting list PL may be stored in the storage apparatus as compressed data or uncompressed data. It is noted that hereinafter, when the posting list PL and the compressed posting list cPL are not distinguished from each other, each of the posting list PL and the compressed posting list cPL is simply referred to as searchable data.

In the search processing, when a query is input to the information processing apparatus, a first-stage search is executed by using the above-described graph functioning as an index. Hereinafter, the first-stage search in the search processing will be referred to as first search processing. The first search processing is processing of searching the plurality of representative vectors RV for the representative vector RV close to a query vector QV based on the input query. More specifically, when the query is input, for example, a distance D between the query vector QV based on the input query and each representative vector RV is calculated. FIG. 1 illustrates distances D(1), D(2), . . . and D(n) between the query vector QV and each of the representative vectors RV1, RV2, . . . , and RVn. Among the plurality of representative vectors RV, for example, j (j is an integer equal to or larger than 1) representative vectors RV are selected in an ascending order of the distance to the query vector QV.

Thereafter, the searchable data of the j posting lists PL corresponding to the selected j representative vectors RV is transferred from the storage apparatus to a memory of the information processing apparatus. That is, based on a result of the first search processing, j pieces of searchable data necessary for the search processing are transferred from the storage apparatus to the memory. It is noted that each of the j posting lists PL is also referred to as a selected posting list PL (or a candidate posting list PL). The searchable data related to the selected posting list PL is also referred to as selected searchable data.

Then, based on the j pieces of selected searchable data transferred to the memory, a second-stage search is executed on the j selected posting lists PL. Hereinafter, the second-stage search in the t search processing will be referred to as second search processing. The second search processing is processing of searching the vector information VI in the j selected posting lists PL for a vector information VI close to the query vector QV. More specifically, based on the j pieces of selected searchable data, the calculation of the distance D between the query vector QV and a plurality of pieces of vector information VI included in each of the j selected posting lists PL is executed. Among the plurality of pieces of vector information VI in the j selected posting lists PL, for example, a vector information VI closest to the query vector QV is selected as a neighboring vector.

### 1.2 Configuration

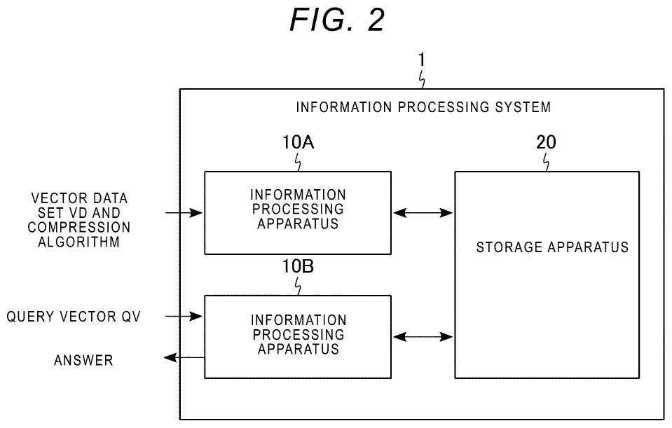

Hereinafter, the information processing system according to the embodiment will be described in detail with reference to FIG. 2. FIG. 2 is a block diagram illustrating an example of a configuration of the information processing system according to the embodiment. As illustrated in FIG. 2, an information processing system 1 includes, for example, information processing apparatuses 10A and 10B and a storage apparatus 20. It is noted that in the following description, when the information processing apparatuses 10A and 10B are not distinguished from each other, the information processing apparatuses 10A and 10B are simply referred to as an information processing apparatus 10. Hereinafter, a case is described in which the information processing apparatuses 10A and 10B and the storage apparatus 20 are implemented as different apparatuses in the information processing system 1, and the present disclosure is not limited thereto. Configurations of two or all of the information processing apparatuses 10A and 10B and the storage apparatus 20 may be implemented as one apparatus. In this case, the one apparatus may implement functions of the information processing apparatuses 10A and 10B and the storage apparatus 20 to be described below.

Each information processing apparatus 10 is, for example, a computer. It is noted that each information processing apparatus 10 may be, for example, a server connected to a network.

For example, the information processing apparatus 10A executes the index generation processing based on a vector data set VD including the plurality of pieces of vector information VI. More specifically, in the index generation processing, the information processing apparatus 10A classifies the plurality of pieces of vector information VI included in the vector data set VD into the plurality of posting lists PL. The information processing apparatus 10A receives, for example, a compression algorithm from an outside. Then, the information processing apparatus 10A compresses the data for each posting list PL based on the received compression algorithm. Then, the information processing apparatus 10A transmits the compressed posting list cPL (searchable data) to the storage apparatus 20.

It is noted that FIG. 2 illustrates a case in which the information processing apparatus 10A receives the compression algorithm from the outside, and the present disclosure is not limited thereto. The information processing apparatus 10A may not receive the compression algorithm from the outside. In this case, the information processing apparatus 10A determines each posting list PL to be the target posting list PL that is a compression target or the non-target posting list PL that is not a compression target. The information processing apparatus 10A determines, for example, the compression algorithm used for compressing each target posting list PL. The information processing apparatus 10A uses the compression algorithm determined for each target posting list PL to compress the target posting list PL. The non-target posting list PL is not compressed. Then, the information processing apparatus 10A transmits the compressed target posting list cPL and the non-target posting list PL (searchable data) to the storage apparatus 20.

The information processing apparatus 10B executes the search processing based on the query vector QV received from the outside. It is noted that the information processing apparatus 10B may generate the query vector QV based on a query received from the outside. The information processing apparatus 10B executes the first search processing, a transfer request of the searchable data to the storage apparatus 20, and the second search processing using the transferred searchable data. Then, the information processing apparatus 10B outputs the vector information VI determined by the search processing to the outside as an answer. In this way, the information processing apparatus 10B uses information stored in the storage apparatus 20 when searching for the answer to the query vector QV.

The storage apparatus 20 is a storage medium capable of storing data in a non-volatile manner. The storage apparatus 20 is, for example, an HDD or an SSD. It is noted that the storage apparatus 20 may be a single NAND flash memory instead of the HDD and the SSD. The storage apparatus 20 may store a plurality of pieces of searchable data. The storage apparatus 20 may be directly or indirectly connected to each information processing apparatus 10. Communication between each information processing apparatus 10 and the storage apparatus 20 may be wired communication or wireless communication, or may be performed via the network. It is noted that the information processing system 1 may include a plurality of the storage apparatuses 20.

### 1.2.1 Hardware Configuration

Hardware configurations of the information processing apparatuses 10A and 10B and the storage apparatus 20 provided in the information processing system 1 according to the embodiment will be described.

### 1.2.1.1 Hardware Configuration of Information Processing Apparatus

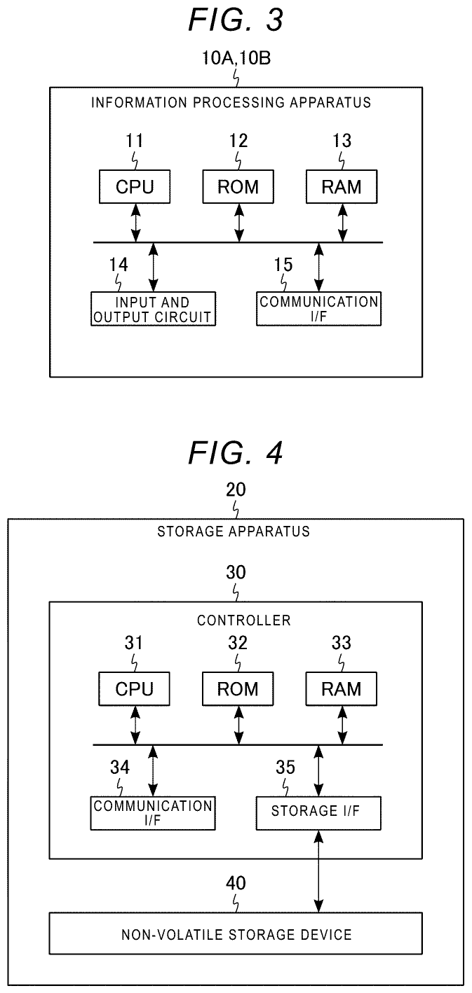

The hardware configuration of the information processing apparatuses 10A and 10B provided in the information processing system 1 according to the embodiment will be described with reference to FIG. 3. FIG. 3 is a block diagram illustrating an example of the hardware configuration of the information processing apparatus provided in the information processing system according to the embodiment. Hereinafter, a hardware configuration that may be the same in the information processing apparatuses 10A and 10B, and different hardware configurations will be described.

The information processing apparatus 10 includes, for example, a central processing unit (CPU) 11, a read only memory (ROM) 12, a random access memory (RAM) 13, an input and output circuit 14, and a communication interface (communication I/F) 15. The CPU 11, the ROM 12, the RAM 13, the input and output circuit 14, and the communication interface 15 are connected via a bus.

The CPU 11 is a processor that executes various programs related to control of the information processing apparatus 10. Plural CPUs 11 may be provided depending on programs to be executed.

The ROM 12 is a non-volatile storage device that stores a control program of the information processing apparatus 10.

The RAM 13 is a volatile storage device used as a work area of the CPU 11. The RAM 13 may be a non-volatile storage device as long as being used as the work area of the CPU 11. The RAM 13 is, for example, an SRAM or a DRAM. It is noted that data stored (loaded) in the RAM 13 is used when the information processing apparatus 10A executes the index generation processing. Data stored (loaded) in the RAM 13 is used when the information processing apparatus 10B executes the first search processing and the second search processing.

The input and output circuit 14 handles a signal input to the information processing apparatus 10 and a signal output from the information processing apparatus 10. For example, the vector data set VD and the compression algorithm are input from the outside to the input and output circuit 14 in the information processing apparatus 10A. For example, the query vector QV is input to the input and output circuit 14 in the information processing apparatus 10B. Then, an answer to the query vector QV is output from the input and output circuit 14 in the information processing apparatus 10B. The input and output circuit 14 in the information processing apparatus 10B may include an encoder that generates the query vector QV based on a query received from the outside.

The communication interface 15 is an interface circuit used for communication with the storage apparatus 20. For example, the searchable data is output from the communication interface 15 in the information processing apparatus 10A. For example, the searchable data selected by the information processing apparatus 10B is input to the communication interface 15 in the information processing apparatus 10B.

It is noted that when the hardware configuration provided in the information processing apparatuses 10A and 10B is provided in one apparatus, a CPU, a ROM, a RAM, an input and output circuit, and a communication interface of the one apparatus may execute processing executed by the CPU 11, the ROM 12, the RAM 13, the input and output circuit 14, and the communication interface 15 in each of the information processing apparatuses 10A and 10B.

### 1.2.1.2 Hardware Configuration of Storage Apparatus

The hardware configuration of the storage apparatus 20 provided in the information processing system 1 according to the embodiment will be described with reference to FIG. 4. FIG. 4 is a block diagram illustrating an example of the hardware configuration of the storage apparatus provided in the information processing system according to the embodiment.

The storage apparatus 20 includes a controller 30 and a non-volatile storage device 40.

The controller 30 can control the non-volatile storage device 40 in response to a request from the information processing apparatus 10. The controller 30 includes, for example, a CPU 31, a ROM 32, a RAM 33, a communication interface (communication I/F) 34, and a storage interface (storage I/F) 35. The CPU 31, the ROM 32, the RAM 33, the communication interface 34, and the storage interface 35 are connected via a bus.

The CPU 31 is a processor that executes various programs related to control of the controller 30. The ROM 32 is a non-volatile storage device that stores a control program of the controller 30.

The RAM 33 is a volatile storage device used as a work area of the CPU 31. The RAM 33 may be a non-volatile storage device as long as being used as the work area of the CPU 31.

The communication interface 34 is an interface circuit used for communication with the information processing apparatus 10.

The storage interface 35 is an interface circuit used for communication with the non-volatile storage device 40.

The non-volatile storage device 40 stores data in a non-volatile manner.

It is noted that when the information processing apparatus 10 and the storage apparatus 20 are implemented as one apparatus, the one apparatus includes, for example, a storage interface and a non-volatile storage device in addition to the configuration of the above-described information processing apparatus 10. For example, the CPU 11, the ROM 12, the RAM 13, and the communication interface 15 of the above-described information processing apparatus 10 may execute processing executed by the CPU 31, the ROM 32, the RAM 33, and the communication interface 34, respectively.

### 1.2.2 Functional Configuration

### 1.2.2.1 Functional Configuration of Information Processing Apparatus 10A

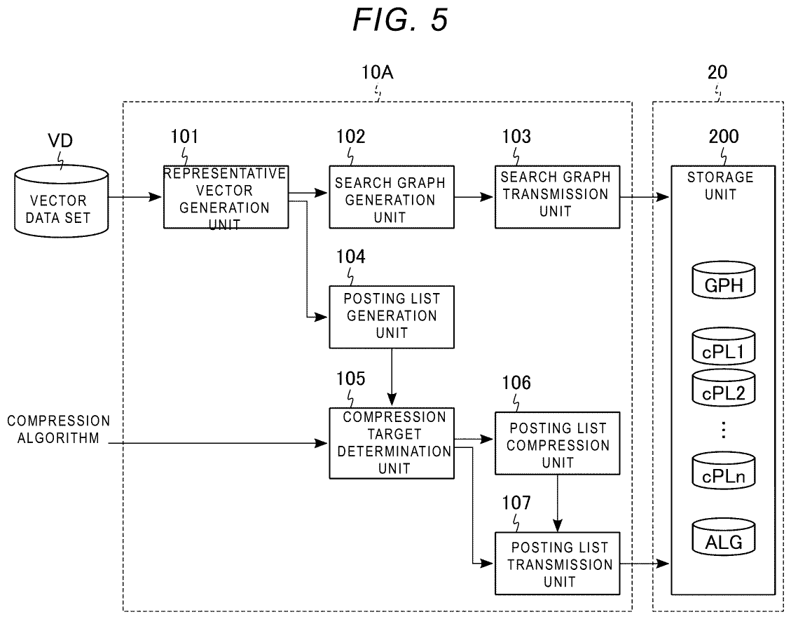

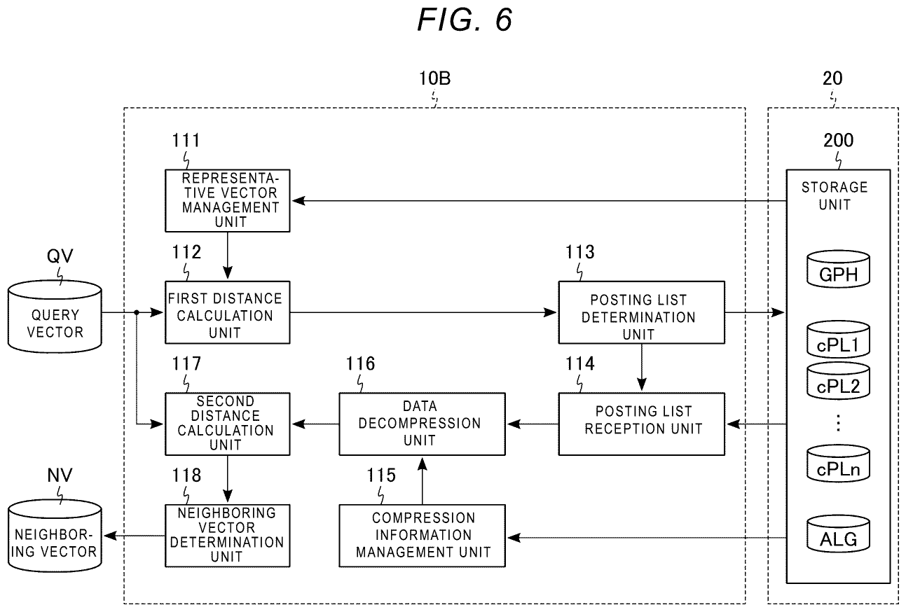

A functional configuration of the information processing apparatus 10A will be described with reference to FIG. 5. FIG. 5 is a block diagram illustrating an example of a functional configuration of the information processing system according to the embodiment. FIG. 5 illustrates a functional configuration of the storage apparatus 20 together with the functional configuration of the information processing apparatus 10A.

The information processing apparatus 10A includes a representative vector generation unit 101, a search graph generation unit 102, a search graph transmission unit 103, a posting list generation unit 104, a compression target determination unit 105, a posting list compression unit 106, and a posting list transmission unit 107. The storage apparatus 20 includes a storage unit 200 that stores various types of data.

For example, the representative vector generation unit 101 receives the vector data set VD from the outside. The representative vector generation unit 101 executes clustering processing on the received vector data set VD. Accordingly, the representative vector generation unit 101 generates the plurality of representative vectors RV. The representative vector generation unit 101 transmits the generated plurality of representative vectors RV to the search graph generation unit 102. In addition, the representative vector generation unit 101 transmits the plurality of representative vectors RV and the vector data set VD to the posting list generation unit 104.

The search graph generation unit 102 generates a search graph GPH based on the plurality of representative vectors RV received from the representative vector generation unit 101. The search graph generation unit 102 transmits the search graph GPH to the search graph transmission unit 103. The search graph GPH constitutes a data structure in which the plurality of representative vectors RV are presented. The search graph GPH is used by the information processing apparatus 10B during the first search processing.

The search graph transmission unit 103 transmits the search graph GPH to the storage unit 200.

The posting list generation unit 104 generates the plurality of posting lists PL based on the plurality of representative vectors RV and the vector data set VD which are received from the representative vector generation unit 101. That is, the posting list generation unit 104 uses the plurality of representative vectors RV to classify the plurality of pieces of vector information VI included in the vector data set VD into the plurality of posting lists PL. The posting list generation unit 104 transmits the generated plurality of posting lists PL to the compression target determination unit 105.

The compression target determination unit 105 receives the plurality of posting lists PL from the posting list generation unit 104. The compression target determination unit 105 may receive the compression algorithm from the outside. When the compression algorithm is received from the outside, the compression target determination unit 105 sets all the posting lists PL as the compression target posting lists PL. The compression target determination unit 105 transmits the received compression algorithm and the plurality of posting lists PL to the posting list compression unit 106. When the compression algorithm is not received from the outside, the compression target determination unit 105 determines whether to compress data for each of the plurality of posting lists PL. The compression target determination unit 105 sets the posting list PL determined to compress the data as the compression target posting list PL, and sets the posting list PL determined not to compress the data as the compression non-target posting list PL. The compression target determination unit 105 determines the compression algorithm corresponding to each of the target posting lists PL. Then, the compression target determination unit 105 transmits the target posting list PL and the compression algorithm determined for the target posting list PL to the posting list compression unit 106. The compression target determination unit 105 transmits the non-target posting list PL to the posting list transmission unit 107.

It is noted that the compression algorithm received from the outside and the compression algorithm determined by the compression target determination unit 105 are compression algorithms using, for example, run length encoding (RLE), variable length encoding, and delta encoding. The compression algorithm may be, for example, a compression algorithm used by combining two or more methods among methods such as run length encoding, variable length encoding, and delta encoding. The run length encoding, the variable length encoding, and the delta encoding will be described below.

The posting list compression unit 106 compresses the posting list PL based on the target Posting list PL and the compression algorithm received from the compression target determination unit 105.

More specifically, when the compression target determination unit 105 receives the compression algorithm from the outside, the posting list compression unit 106 receives the compression algorithm and the plurality of posting lists PL from the compression target determination unit 105. The posting list compression unit 106 uses the compression algorithm to compress each of all the posting lists PL. The posting list compression unit 106 transmits the plurality of compressed posting lists cPL and the compression algorithm to the posting list transmission unit 107.

When the compression target determination unit 105 does not receive the compression algorithm from the outside, the posting list compression unit 106 receives the target posting list PL and the compression algorithm determined for the target posting list PL from the compression target determination unit 105. The posting list compression unit 106 compresses the target posting list PL based on the compression algorithm determined for each target posting list PL. The posting list compression unit 106 transmits the compressed target posting list cPL and the compression algorithm used to generate the compressed target posting list cPL to the posting list transmission unit 107.

It is noted that FIG. 5 illustrates an example of a case in which all of the posting lists PL1 to PLn are compressed based on the compression algorithm received from the outside.

The posting list transmission unit 107 transmits the plurality of pieces of searchable data to the storage unit 200. The posting list transmission unit 107 may further transmit the compression algorithm to the storage unit 200.

More specifically, when the compression target determination unit 105 receives the compression algorithm from the outside, the posting list transmission unit 107 transmits all the compressed posting lists cPL (searchable data) received from the posting list compression unit 106 to the storage unit 200. The posting list transmission unit 107 transmits the compression algorithm received from the outside to the storage unit 200 as the compression algorithm used for compressing all the posting lists PL.

When the compression target determination unit 105 does not receive the compression algorithm from the outside, the posting list transmission unit 107 may transmit the compressed target posting list cPL (searchable data) received from the posting list compression unit 106 and the non-target posting list PL (searchable data) received from the compression target determination unit 105 to the storage unit 200. The posting list transmission unit 107 may transmit, for example, the compression algorithm determined by the compression target determination unit 105 to the storage unit 200 in association with the compressed target posting list cPL.

The compression algorithm transmitted to the storage unit 200 in this way is stored as, for example, compression algorithm information ALG in the storage unit 200. In the compression algorithm information ALG, for example, the compression algorithm used to generate each of the compressed posting lists cPL is stored in association with the compressed posting list cPL. It is noted that when the compression target determination unit 105 receives the compression algorithm from the outside, it is sufficient that the compression algorithm information ALG is configured such that it is possible to determine that the compression algorithm received from the outside has been used to compress all of the posting lists PL.

### 1.2.2.2 Functional Configuration of Information Processing Apparatus 10B

A functional configuration of the information processing apparatus 10B will be described with reference to FIG. 6. FIG. 6 is a block diagram illustrating another example of the functional configuration of the information processing system according to the embodiment. The information processing apparatus 10B includes a representative vector management unit 111, a first distance calculation unit 112, a posting list determination unit 113, a posting list reception unit 114, a compression information management unit 115, a data decompression unit 116, a second distance calculation unit 117, and a neighboring vector determination unit 118.

The representative vector management unit 111 acquires the search graph GPH in which the plurality of representative vectors RV are presented from the storage unit 200. The representative vector management unit 111 transmits the acquired search graph GPH to the first distance calculation unit 112. The representative vector management unit 111 may transmit not only the acquired search graph GPH but also information on the plurality of representative vectors RV based on the search graph GPH to the first distance calculation unit 112.

The first distance calculation unit 112 receives the query vector QV from the outside. The first distance calculation unit 112 that receives the query vector QV acquires the search graph GPH including the plurality of representative vectors RV of the plurality of posting lists PL from the representative vector management unit 111. Then, the first distance calculation unit 112 calculates the distance between the query vector QV and each of the plurality of representative vectors RV and transmits a calculation result to the posting list determination unit 113. For example, the first distance calculation unit 112 traces the search graph GPH while calculating the distance between each node (i.e., each representative vector RV) of the search graph GPH and the query vector QV.

In the first search processing, the posting list determination unit 113 selects the j selected posting lists PL which are targets in the second search processing based on the calculation result of the distance between the query vector QV and the representative vector RV received from the first distance calculation unit 112. It is noted that the number of the selected posting lists PL may be determined in advance, or may be determined according to features of the query vector QV and the plurality of pieces of vector information VI. The posting list determination unit 113 transmits the transfer request of the searchable data for the selected j selected posting lists PL (j pieces of selected searchable data) to the storage unit 200. The transfer request includes address information on the j pieces of selected searchable data. For example, the posting list determination unit 113 further transmits transfer information including a list of the j pieces of selected searchable data (or the posting lists PL) to the posting list reception unit 114.

The posting list reception unit 114 acquires the j pieces of selected searchable data from the storage unit 200 based on the transfer information received from the posting list determination unit 113. Then, the posting list reception unit 114 transmits the received searchable data to the data decompression unit 116.

In response to the transfer request from the posting list determination unit 113, the storage unit 200 transmits the j pieces of selected searchable data to the posting list reception unit 114. More specifically, in the storage apparatus 20, the controller 30 transmits a read instruction of the searchable data stored in the address based on the transfer request to the non-volatile storage device 40. Then, the non-volatile storage device 40 reads the searchable data from the specified address and transmits the read searchable data to the controller 30. Then, the controller 30 transmits the searchable data acquired from the non-volatile storage device 40 to the posting list reception unit 114.

When the selected searchable data is the compressed posting list cPL, the compression information management unit 115 acquires the compression algorithm used to generate the compressed posting list cPL from the storage unit 200 based on the compression algorithm information ALG. Then, the compression information management unit 115 transmits the acquired compression algorithm to the data decompression unit 116. That is, when the selected searchable data is the compressed posting list cPL, the storage unit 200 transmits the compression algorithm used to generate the compressed posting list CPL to the compression information management unit 115 based on the compression algorithm information ALG.

The data decompression unit 116 determines whether each of the j pieces of selected searchable data is data of the posting list PL or the compressed posting list cPL. When the selected searchable data is the posting list PL, the data decompression unit 116 transmits the posting list PL to the second distance calculation unit 117. When the selected searchable data is the compressed posting list cPL, the data decompression unit 116 decompresses the compressed posting list cPL based on the compression algorithm which is used to generate the compressed posting list cPL and is received from the compression information management unit 115. Then, the data decompression unit 116 transmits the decompressed posting list PL to the second distance calculation unit 117. In this way, the data decompression unit 116 transmits the j selected posting lists PL to the second distance calculation unit 117.

The second distance calculation unit 117 receives the query vector QV, similarly to the first distance calculation unit 112. The second distance calculation unit 117 calculates a distance between the query vector QV and each vector information VIN in the j selected posting lists PL received from the data decompression unit 116. The second distance calculation unit 117 transmits a result of the calculation to the neighboring vector determination unit 118.

The neighboring vector determination unit 118 determines at least one neighboring vector NV based on the result of the calculation received from the second distance calculation unit 117, for example, in an ascending order of the distance between the query vector QV and each vector information VIN in the j selected posting lists PL. Then, the neighboring vector determination unit 118 outputs the determined neighboring vector NV to the outside. It is noted that the number of neighboring vectors NV determined and output by the neighboring vector determination unit 118 may vary according to a setting of the approximate nearest neighbor search, and may be one, or may be two or more.

### 1.3 Operation

The approximate nearest neighbor search performed by the information processing system 1 according to the embodiment will be described.

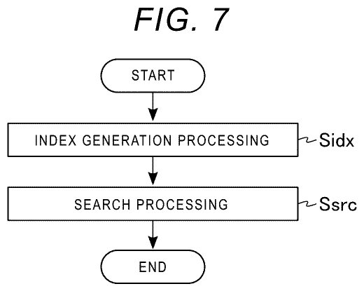

An overall flow of the approximate nearest neighbor search performed by the information processing system 1 according to the embodiment will be described with reference to FIG. 7. FIG. 7 is a flowchart illustrating the overall flow of approximate nearest neighbor search in the information processing system according to the embodiment.

In the approximate nearest neighbor search in the information processing system 1 according to the embodiment, first, the index generation processing is executed (Sidx).

Then, the search processing is executed (Ssrc).

Hereinafter, the index generation processing and the search processing will be described in order.

### 1.3.1 Index Generation Processing

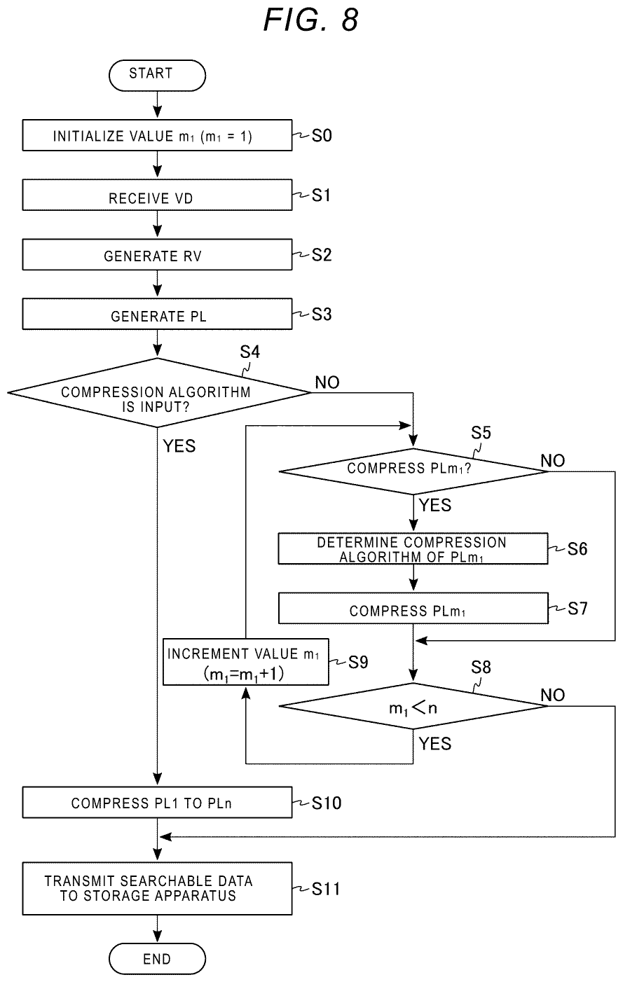

The index generation processing performed by the information processing system 1 according to the embodiment will be described with reference to FIG. 8. FIG. 8 is a flowchart illustrating an example of the index generation processing in the approximate nearest neighbor search performed by the information processing system according to the embodiment.

When the index generation processing is started (S0), the information processing apparatus 10A initializes a value m₁ (m₁=1).

Next, the representative vector generation unit 101 receives the vector data set VD (S1).

Then, the representative vector generation unit 101 uses the vector data set VD to generate the plurality of representative vectors RV (S2).

Then, the posting list generation unit 104 uses the vector data set VD and the plurality of representative vectors RV to generate the plurality of posting lists PL (S3). That is, the information processing apparatus 10A classifies the plurality of pieces of vector information VI included in the vector data set VD into the plurality of posting lists PL. In (S3), the search graph generation unit 102 uses, for example, the plurality of representative vectors RV to generate the search graph GPH.

Next, the compression target determination unit 105 determines whether the compression algorithm is received from the outside (S4). When the compression algorithm is received from the outside (YES in S4), the processing proceeds to (S10). When the compression algorithm is not received from the outside (NO in S4), the processing proceeds to (S5).

When the compression algorithm is not received from the outside (NO in S4), the compression target determination unit 105 determines whether to compress an m₁-th posting list PLm₁ among the plurality of posting lists PL (S5). More specifically, for example, the compression target determination unit 105 determines whether there is a suitable compression algorithm for the posting list PLm₁. When there is a compression algorithm determined to be suitable, the compression target determination unit 105 sets the posting list PLm₁ as the compression target posting list PL. When there is no compression algorithm determined to be suitable, the compression target determination unit 105 sets the posting list PLm₁ as the compression non-target posting list PL. When the posting list PLm₁ is set as the target posting list PL (YES in S5), the processing proceeds to (S6). When the posting list PLm₁ is set as the non-target posting list PL (NO in S5), the compression target determination unit 105 transmits the posting list PLm₁ to the posting list transmission unit 107 as the searchable data. Then, the processing proceeds to (S8).

When the posting list PLm₁ is set as the target posting list PL (YES in S5), the compression target determination unit 105 determines, for example, a compression algorithm to be used to compress the posting list PLm₁ based on the compression algorithm determined to be suitable (S6). Hereinafter, an example in which the compression algorithm is determined to be suitable will be described.

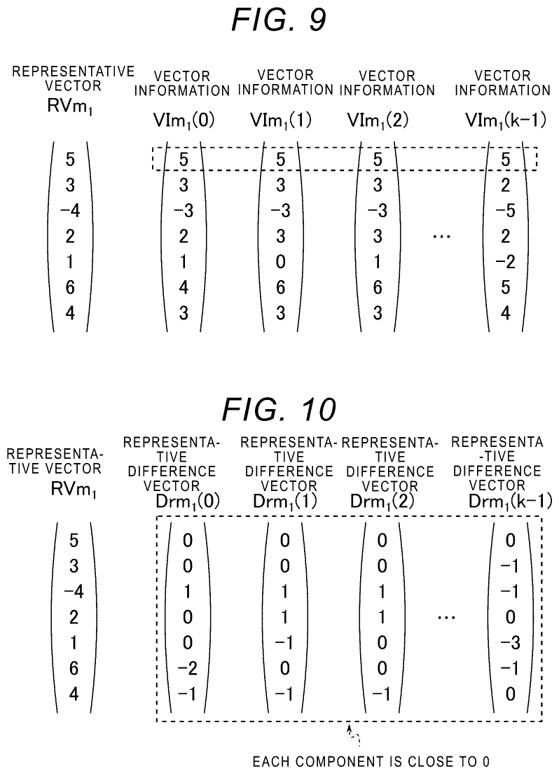

A case in which the run length encoding, the variable length encoding, and the delta encoding are used as examples of the compression algorithm will be described with reference to FIGS. 9, 10, and 11, respectively. FIGS. 9, 10, and 11 are diagrams illustrating examples of the compression of the posting list in the index generation processing in the approximate nearest neighbor search performed by the information processing system according to the embodiment. In FIGS. 9, 10, and 11, each component included in a vector is included in the same row for the posting list PLm₁.

In the SPANN, since the plurality of posting lists PL are generated based on the clustering processing as described above, for example, a correlation coefficient between different vector information VIm₁ included in the posting list PLm₁ becomes high. Accordingly, as components surrounded by a dotted line in FIG. 9, the same value may continue in the same component in a plurality of pieces of vector information VIm₁. FIG. 9 illustrates an example of a representative vector RVm₁ and the plurality of vector information VIm₁. In this case, the compression target determination unit 105 determines, for example, that the run length encoding is suitable.

Further, due to the same reason as the correlation coefficient between the different vector information VIm₁, a correlation coefficient between vector information VIm₁ included in the posting list PLm₁ and the representative vector RVm₁ may also be high. In this case, the compression target determination unit 105 determines, for example, that the variable length encoding is suitable. The above will be supplemented with reference to FIG. 10. FIG. 10 illustrates an example of the same representative vector RVm₁ and the plurality of pieces of vector information VIm₁ as those in the example in FIG. 9. When the correlation coefficient between the vector information VIm₁ and the representative vector RVm₁ is high, as illustrated in a portion surrounded by a dotted line in FIG. 10, each component of a representative difference vector Drm₁ (Drm₁=VIm₁−RVm₁) obtained by subtracting the representative vector RVm₁ from each of the plurality of pieces of vector information VIm₁ indicates, for example, a value close to 0. In this way, when the occurrence frequency of the value of each component of the representative difference vector Drm₁ is biased, the compression target determination unit 105 may determine that the compression using the variable length encoding is suitable.

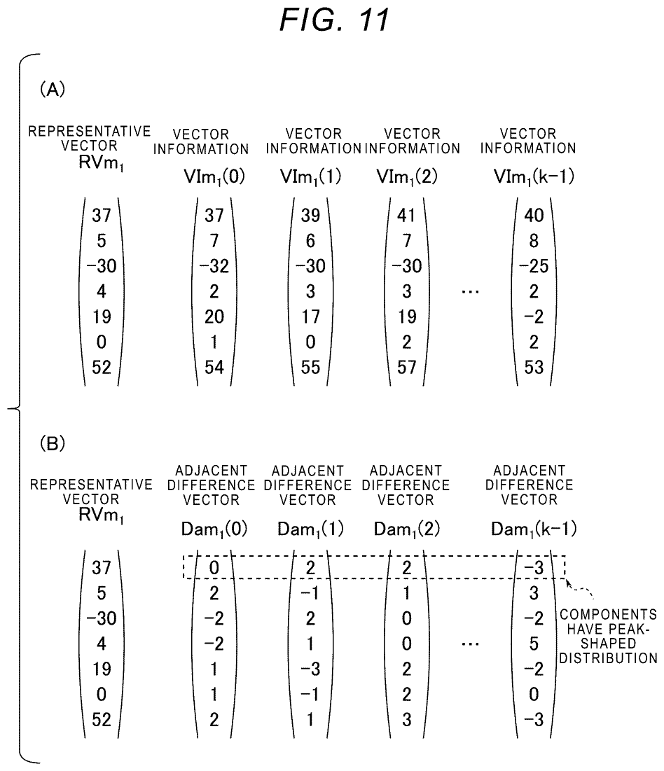

When values of components of the adjacent vector information VIm₁ are close to each other, the compression target determination unit 105 determines, for example, that the compression algorithm using the delta encoding is suitable. (A) of FIG. 11 illustrates an example of the representative vector RVm₁ and the plurality of pieces of vector information VIm₁ different from those in the example in FIG. 9. (B) of FIG. 11 illustrates an example of the representative vector RVm₁ and a plurality of adjacent difference vectors Dam₁ generated by the delta encoding. The adjacent difference vector Dam₁ is, for example, a difference vector between two pieces of vector information VIm₁ adjacent to each other when a plurality of pieces of vector information VIm₁(0) to VIm₁(k−1) are arranged in a line in this order. More specifically, an adjacent difference vector Dam₁ (p) (p is a natural number equal to or less than (k−1)) is a vector obtained by subtracting vector information VIm₁ (p−1) from vector information VIm₁ (p). The adjacent difference vector Dam₁(0) is, for example, a vector obtained by subtracting the representative vector RVm₁ from the vector information VIm₁ (0). In this way, when the values of the components of the adjacent vector information VIm₁ are close to each other, values of the plurality of adjacent difference vectors Dam₁ may form a peak-shaped distribution centered on 0. Accordingly, high compression efficiency is implemented by applying a compression method using a variable length code such as a Huffman code to the plurality of adjacent difference vectors Dam₁. Therefore, the compression target determination unit 105 may determine that the compression algorithm using the delta encoding is suitable.

It is noted that in this way, the compression target determination unit 105 may apply a compression algorithm obtained by combining two or more of, for example, the run length encoding, the variable length encoding, and the delta encoding to the compression of the posting list PLm₁.

Referring back to FIG. 8, the index generation processing will be described. The posting list compression unit 106 uses the compression algorithm determined by the compression target determination unit 105 for the posting list PLm₁ to compress the posting list PLm₁ (S7). The posting list compression unit 106 transmits the compressed posting list cPLm₁ to the posting list transmission unit 107 as the searchable data. The posting list compression unit 106 transmits the compression algorithm used to generate the compressed posting list cPLm₁ to the posting list transmission unit 107. Then, the processing proceeds to (S8).

In (S8), the information processing apparatus 10A determines whether the value m₁ is less than the value n. When the value m₁ is less than the value n (YES in S8), the processing proceeds to (S9). When the value m₁ is equal to or larger than the value n (NO in S8), the processing proceeds to (S11).

Then, in (S9), the information processing apparatus 10A increments the value m₁ (m₁=m₁+1). Then, the processing proceeds to (S5).

When the compression algorithm is received from the outside (YES in S4), the posting list compression unit 106 sets all the posting lists PL as the target posting list PL. Then, the posting list compression unit 106 uses the compression algorithm received from the outside to compress each of the posting lists PL1 to PLn (S10). The posting list compression unit 106 transmits the compressed posting list cPL to the posting list transmission unit 107 as the searchable data for all the posting lists PL. The posting list compression unit 106 transmits the compression algorithm received from the outside to the posting list transmission unit 107. Then, the processing proceeds to (S11).

Then, the posting list transmission unit 107 transmits a plurality of pieces of searchable data relating to the posting lists PL1 to PLn to the storage unit 200 of the storage apparatus 20 (S11). In addition, the posting list transmission unit 107 transmits the compression algorithm received from the outside or the compression algorithm which is determined by the compression target determination unit 105 and which is used to generate each of the compressed posting lists cPL to the storage unit 200 of the storage apparatus 20.

In this way, the index generation processing is executed.

### 1.3.2 Search Processing

Next, the search processing performed by the information processing system 1 according to the embodiment will be described.

### 1.3.2.1 Outline

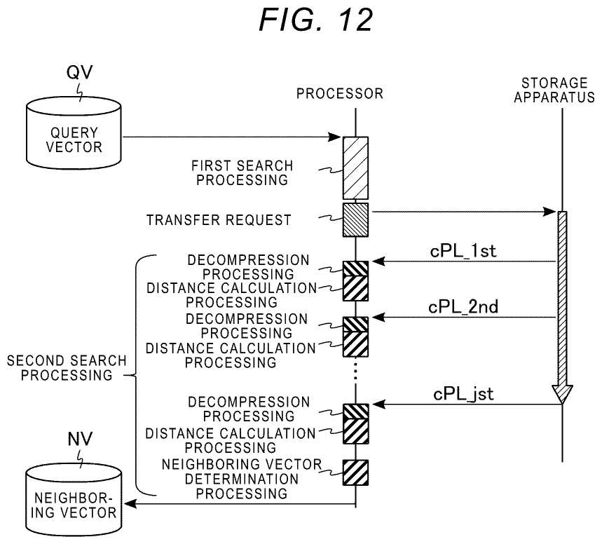

An overview of the search processing performed by the information processing system 1 according to the embodiment will be described with reference to FIG. 12. FIG. 12 is a sequence diagram illustrating an example of a processing sequence of the search processing in the approximate nearest neighbor search performed by the information processing system according to the embodiment.

When receiving the query vector QV, the information processing apparatus 10B executes the first search processing. Then, based on the result of the first search processing, the information processing apparatus 10B requests the storage apparatus 20 to transfer the searchable data for the j selected posting lists PL (transfer request).

Next, in the second search processing, the storage apparatus 20 sequentially transfers the j pieces of selected searchable data to the information processing apparatus 10B based on the transfer request received from the information processing apparatus 10B. It is noted that FIG. 12 illustrates an example in which all the j pieces of selected searchable data are stored in the storage apparatus 20 as the compressed posting lists cPL_1st to CPL_jst.

It is noted that an order of the searchable data transferred by the storage apparatus 20 is based on, for example, a content of the transfer request. For example, the posting list determination unit 113 of the information processing apparatus 10B transmits, to the storage apparatus 20, the transfer request of the searchable data in an ascending order of the distance between the query vector QV and the representative vector RV of the corresponding posting list PL. Then, in response to the transfer request, the storage apparatus 20 transfers, to the posting list reception unit 114 of the information processing apparatus 10B, the searchable data in an ascending order of the distance.

When the searchable data received from the storage apparatus 20 is the compressed posting list cPL, the information processing apparatus 10B executes decompression processing on the compressed posting list cPL. When the searchable data received from the storage apparatus 20 is the posting list PL which is not compressed, the information processing apparatus 10B does not execute the decompression processing. Then, for example, every time the searchable data is transferred, the information processing apparatus 10B calculates (executes distance calculation processing) the distance between each of the plurality of pieces of vector information VI included in each posting list PL and the query vector QV.

It is noted that although not illustrated in FIG. 12, to execute the decompression processing on the compressed posting list cPL, for example, the information processing apparatus 10B acquires, from the storage unit 200, the compression algorithm used to generate the compressed posting list cPL based on the compression algorithm information ALG every time the compressed posting list cPL is transferred.

Then, the information processing apparatus 10B determines the neighboring vector NV based on a result of the distance calculation processing for each of the j posting lists PL. The information processing apparatus 10B outputs the determined neighboring vector NV as an answer to the query.

### 1.3.2.2 Flowchart

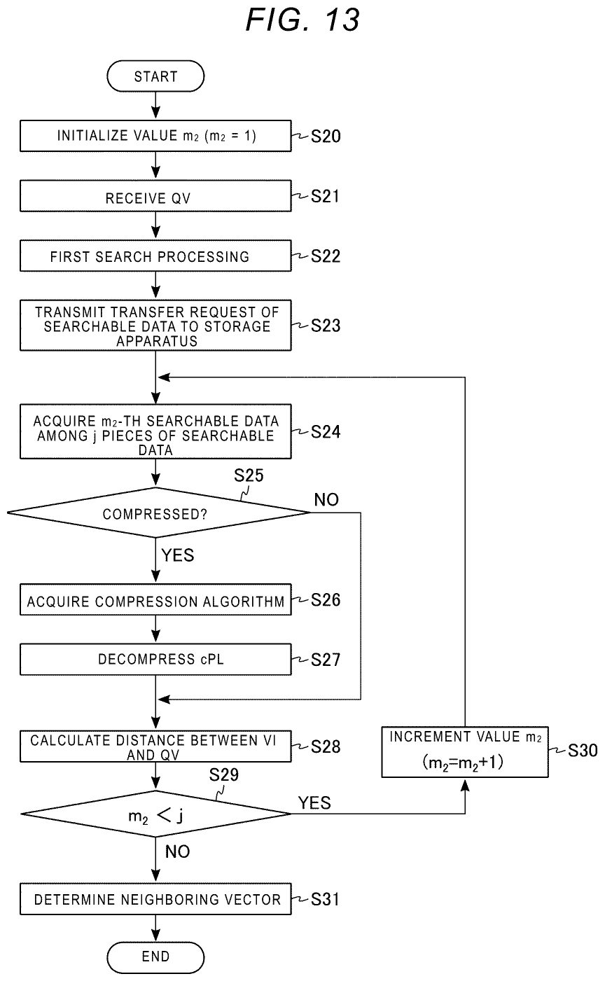

A flowchart of the search processing performed by the information processing system 1 according to the embodiment will be described with reference to FIG. 13. FIG. 13 is a flowchart illustrating an example of the search processing in the approximate nearest neighbor search performed by the information processing system according to the embodiment.

When the search processing is started, the information processing apparatus 10B initializes a value m₂ (m₂=1) in (S20).

Next, the first distance calculation unit 112 receives the query vector QV (S21). The representative vector management unit 111 receives the search graph GPH including the plurality of representative vectors RV from the storage unit 200 of the storage apparatus 20.

Then, the first distance calculation unit 112 executes the first search processing (S22). Accordingly, the posting list determination unit 113 selects the j representative vectors RV among the plurality of representative vectors RV and the j posting lists PL corresponding to the j representative vectors RV. More specifically, for example, the first distance calculation unit 112 calculates the distance between the query vector QV and the representative vector RV while tracing the search graph GPH. The posting list determination unit 113 selects the j representative vectors RV based on the result of the calculation.

Next, the posting list determination unit 113 transmits the transfer request of the searchable data to the storage apparatus 20 (S23). The transfer request includes the address information on the searchable data determined by the processing in S22. Then, the controller 30 of the storage apparatus 20 stores the read instruction targeting the address information included in the transfer request in a queue. Then, the controller 30 reads the searchable data from the non-volatile storage device 40 according to the read instruction stored in the queue.

Then, the posting list reception unit 114 receives, from the storage apparatus 20, the searchable data (m₂-th searchable data) for the m₂-th posting list PL among the j selected posting lists PL in ascending order of the distance between the query vector QV and the representative vector RV (S24).

Then, the data decompression unit 116 determines whether the m₂-th searchable data is compressed (S25).

When the m₂-th searchable data is the compressed posting list cPL (YES in S25), the compression information management unit 115 acquires the compression algorithm used to generate the compressed posting list cPL from the storage unit 200 (S26).

Next, the data decompression unit 116 decompresses the m₂-th searchable data (compressed posting list cPL) based on the compression algorithm acquired in the processing in (S26) (S27).

After (S27) or when the m₂-th searchable data is the posting list PL which is not compressed (NO in S25), the second distance calculation unit 117 calculates the distance between the query vector QV and each of the plurality of pieces of vector information VI included in the m₂-th posting list PL (S28).

Then, the information processing apparatus 10B determines whether the value m₂ is less than the value j (S29).

When the value m₂ is less than the value j (YES in $29), the information processing apparatus 10B increments the value m₂ (m₂=m₂+1) in (S30). Then, the processing proceeds to (S24).

When the value m₂ is equal to or larger than the value j (NO in S29), the neighboring vector determination unit 118 determines at least one neighboring vector NV based on the calculation result of the distance between the query vector QV and each of the plurality of pieces of vector information VI for the j posting lists PL (S31). Then, the neighboring vector determination unit 118 outputs the determined neighboring vector NV to the outside.

In this way, the information processing apparatus 10B executes the search processing.

### 1.4 Advantages of Embodiment

According to the information processing system 1 of the embodiment, it is possible to prevent deterioration in search accuracy and reduce latency. Hereinafter, details of advantages of the embodiment will be described.

The approximate nearest neighbor search includes the first search processing targeting the representative vector and the second search processing executed by using data transferred from the storage unit based on a result of the first search processing. In such an approximate nearest neighbor search method, it is preferable to prevent an increase in latency due to the transfer of the data from the storage unit while preventing deterioration in search accuracy.

The information processing apparatus 10A of the information processing system 1 according to the embodiment can compress the posting list PL to be transmitted to the storage unit 200. Accordingly, an amount of data stored in the storage unit 200 can be reduced, and an amount of searchable data transmitted from the storage unit 200 for the second search processing can be reduced.

The information processing apparatus 10B of the information processing system 1 according to the embodiment can decompress the compressed posting list cPL received from the storage unit 200 in the search processing. Accordingly, even when the searchable data stored in the storage unit 200 is the compressed posting list cPL, the information processing apparatus 10B can use the searchable data to execute the second search processing.

According to the configuration described above, according to the embodiment, it is possible to prevent deterioration in search accuracy and reduce latency.

As a supplement, in the approximate nearest neighbor search, when all the posting lists are stored in the storage unit without being compressed, there is a trade-off relationship between the search accuracy and the latency. More specifically, the search accuracy can be improved by increasing the number of selected posting lists in the second search processing, but the latency increases due to an increase in the amount of data transferred from the storage unit to the information processing apparatus. In addition, the amount of data transferred from the storage unit to the information processing apparatus can be reduced and the latency can be reduced by reducing the number of the selected posting lists in the second search processing, but the search accuracy deteriorates. Therefore, when all the posting lists are stored in the storage unit without being compressed, it is difficult to reduce the latency while preventing deterioration in search accuracy.

According to the information processing system 1 of the embodiment, the information processing apparatus 10A can transmit the compressed posting list cPL to the storage unit 200, and the information processing apparatus 10B can decompress the compressed posting list cPL transferred from the storage unit 200. Therefore, it is possible to reduce the latency without reducing the number of the posting lists PL used in the second search processing.

### 2 Others

In the embodiment, the flowcharts used in describing the operations are merely an example. For each operation described with reference to the flowchart, an order of the processing may be changed within a possible range, another processing may be added, or a part of the processing may be omitted.

In the embodiment, a case is described in which each posting list PL includes the representative vector RV, but the present disclosure is not limited thereto. For example, when the representative vector RV associated with each posting list PL is the center-of-gravity vector of the plurality of pieces of vector information VI included in the posting list PL, the representative vector RV may not be included in each posting list PL but may be stored in the search graph GPH. In this case, when compressing each posting list PL, for example, the posting list compression unit 106 of the information processing apparatus 10A does not compress the representative vectors RV associated with the posting list PL. Then, the posting list transmission unit 107 of the information processing apparatus 10A transmits the compressed posting list cPL not including data related to the representative vector RV to the storage unit 200.

In the embodiment, the hardware configuration of each of the information processing apparatuses 10A and 10B and the controller 30 is not limited to the configuration in the embodiment. For example, instead of the CPUs 11 and 31, a micro processing unit (MPU), an application specific integrated circuit (ASIC), or a field-programmable gate array (FPGA) may be used. A part or all of the functions of the information processing apparatuses 10A and 10B and the controller 30 may be implemented by dedicated hardware or may be configured as a program executed by a processor such as a CPU. That is, the functions of the information processing apparatuses 10A and 10B and the controller 30 can be implemented by using a computer and a program. The program may be recorded in a storage medium, or the program may be provided via a network.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A method for searching data from a storage that stores a plurality of searchable data pieces indexed in a form of a structure that includes a plurality of posting lists, each of the posting lists including (1) one or more vectors, each of the one or more vectors corresponding to one of the searchable data pieces, and (2) a representative vector of the one or more vectors, at least one of the posting lists being stored in a compressed state in the storage, the method comprising:
in response to a query, selecting one or more candidate posting lists among the plurality of posting lists, based on a distance between a query vector corresponding to the query and the representative vector of each of the plurality of posting lists;
acquiring the one or more candidate posting lists from the storage;
decompressing one or more compressed posting lists included in the one or more candidate posting lists;
after said decompressing, selecting one or more vectors included in the one or more candidate posting lists based on a distance between the query vector and each of vectors included in the one or more candidate posting lists; and
outputting one or more searchable data pieces corresponding to the selected one or more vectors as an answer to the query.

2. The method according to claim 1, wherein
the storage further stores compression algorithm information of a compression algorithm employed in compressing one of the plurality of posting lists,
the method further comprises, in response to the query, acquiring the compression algorithm information from the storage, and
said decompressing is carried out using the compression algorithm information acquired from the storage.

3. The method according to claim 1, wherein
the storage further stores a graph depicting a structure including the plurality of posting lists,
the method further comprises, in response to the query, acquiring the graph from the storage, and
said selecting one or more candidate posting lists is carried out with reference to the graph acquired from the storage.

4. The method according to claim 1, wherein said selecting one or more candidate posting lists comprises selecting a first number of posting lists in an ascending order of the distance between the query vector and the representative vector.

5. The method according to claim 1, wherein said selecting one or more vectors included in the one or more candidate posting lists comprises selecting a second number of vectors in an ascending order of the distance between the query vector and the vector included in the one or more candidate posting lists.

6. The method according to claim 1, wherein the representative vector included in at least one of the plurality of posting lists comprises a center-of-gravity vector of the one or more vectors included therein.

7. The method according to claim 1, wherein the representative vector included in at least one of the plurality of posting lists comprises one of the one or more vectors included in the posting list, that is closest to a center-of-gravity vector of the one or more vectors included therein.

8. The method according to claim 1, further comprising:
indexing the plurality of searchable data pieces in the form of the structure including the plurality of posting lists;
compressing at least one of the posting lists; and
after said compressing, storing the indexed plurality of searchable data pieces in the storage.

9. The method according to claim 1, wherein each of the plurality of searchable data pieces is an unstructured data piece.

10. A method for storing data in a storage for searching thereof, comprises:
indexing a plurality of searchable data pieces in a form of a structure that includes a plurality of posting lists, each of the posting lists including (1) one or more vectors, each of the one or more vectors corresponding to one of the searchable data pieces, and (2) a representative vector of the one or more vectors;
compressing at least one of the posting lists in accordance with a compression algorithm; and
after said compressing, storing the indexed plurality of searchable data pieces in the storage.

11. The method according to claim 10, further comprising:
storing compression algorithm information of the compression algorithm in the storage.

12. The method according to claim 10, further comprising:
storing a graph depicting the structure including the plurality of posting lists in the storage.

13. The method according to claim 10, wherein said compressing comprises, with respect to one of the plurality of posting lists:
determining whether a suitable compression algorithm for the one of the plurality of posting lists exists based on relationships among components of vectors included therein; and
upon determining that the suitable compression algorithm exists, compressing the one of the plurality of posting lists in accordance with suitable compressing algorithm,
wherein the one of the plurality of posting lists is stored in the storage without compression when it is determined that no suitable compression algorithm exists.

14. The method according to claim 13, wherein the suitable compression algorithm comprises run length encoding, variable length encoding, or delta encoding.

15. The method according to claim 10, wherein the representative vector included in at least one of the plurality of posting lists comprises a center-of-gravity vector of the one or more vectors included therein.

16. The method according claim 10, wherein the representative vector included in at least one of the plurality of posting lists comprises one of the one or more vectors included in the posting list, that is closest to a center-of-gravity vector of the one or more vectors included therein.

17. The method according to claim 10, wherein each of the plurality of searchable data pieces is an unstructured data piece.

18. An information processing system comprising:
a storage that stores a plurality of searchable data pieces indexed in a form of a structure that includes a plurality of posting lists, each of the posting lists including (1) one or more vectors, each of the one or more vectors corresponding to one of the searchable data pieces, and (2) a representative vector of the one or more vectors, at least one of the posting lists being stored in a compressed state in the storage; and
an information processing apparatus connected to the storage and configured to:
in response to a query, select one or more candidate posting lists among the plurality of posting lists, based on a distance between a query vector corresponding to the query and the representative vector of each of the plurality of posting lists;
acquire the one or more candidate posting lists from the storage;
decompress one or more compressed posting lists included in the one or more candidate posting lists;
after decompressing, select one or more vectors included in the one or more candidate posting lists based on a distance between the query vector and each of vectors included in the one or more candidate posting lists; and
output one or more searchable data pieces corresponding to the selected one or more vectors as an answer to the query.

19. The information processing system according to claim 18, wherein
the storage further stores compression algorithm information of a compression algorithm employed in compressing one of the plurality of posting lists, and
the information processing apparatus is configured to:
in response to the query, acquire the compression algorithm information from the storage, and
decompress the one or more compressed posting lists using the compression algorithm information acquired from the storage.

20. The information processing system according to claim 18, wherein
the storage further stores a graph depicting a structure including the plurality of posting lists, and
the information processing apparatus is configured to:
in response to the query, acquire the graph from the storage, and
select one or more candidate posting lists with reference to the graph acquired from the storage.
